(19) United States
(12) Patent Application Publication
(10) Pub. No.: US 2005/0103234 A1
(43) Pub. Date: May 19, 2005

(54) Cementitious composition

(76) Inventor: William McNulty JR., Provo (TC)

Correspondence Address: William J. McNulty, Jr., PO Box 672, Provo, TC

(21) Appl. No.: 10/965,771

(22) Filed: Oct. 18, 2004

Related U.S. Application Data
(60) Provisional application No. 60/512,773, filed on Oct. 21, 2003.

(51) Int. Cl. C04B 7/00

(52) U.S. Cl. 106/712; 106/638; 106/705

(57) ABSTRACT

A cementitious composition is created by adding sodium carbonate (also known as soda ash, natron, sodium carbonate decahydrate, sodium carbonate anhydrous, trona, etc.) and one or more rocks or minerals selected from the calcium carbonate group. A new product is claimed by combining sodium carbonate and one or more rocks or minerals selected from the calcium carbonate group. The combination of sodium carbonate and one or more rocks or minerals from the calcium carbonate group can be either layered or mixed in a dry or wet state. An exothermic reaction starts after the addition of water to the cementitious composition. The composition of the cementitious material can vary between 10% sodium carbonate and 90% of one or more rocks or minerals from the calcium carbonate group to 90% sodium carbonate and 10% of one or more rocks or minerals selected from the calcium carbonate group. Organic or inorganic additives may be added to the mixture to enhance the composition and/or the final cementitious composition. The cementitious composition can be used in a variety of applications not inclusive of forming bricks, interior architecture, artificial stone, table or counter tops, ornaments, repairing damaged cement products, casting, bioabsorbable devices, extruded products, sprayed products, filler, grout, mortar, gunnite, moulded products, composites, cast stonework, agglomerated stone, concrete, nutrient delivery system, drug delivery system, artificial bones or limbs, hardened products, electronics, packaging and other applications not mentioned above.

### CROSS-REFERENCE TO RELATED APPLICATIONS

This application claims the benefit of U.S. Provisional Ser. No. 60/512773, filed Oct. 21, 2003

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

This invention relates to a new form of cementitious composition which finds utility as a binder for aggregate. The invention also relates to a method of forming the cementitious composition by mixing organic or inorganic materials with the cementitious composition. In some instances, aggregate is added prior to, subsequent to, or simultaneous with the addition of water to create a concrete-like material.

2. Description of the Related Art

Hydraulic cements are known, the most widely encountered being Portland Cement, in which an inorganic material is heat treated at high temperatures, generally in a kiln, to activate the cement. When subsequently mixed with water, this cement hardens. When aggregate is added to the cement, it is generally known as concrete.

The invention relates to a new type of cementitious material formed of inorganic substances that do not require the high temperature heat treatment associated with Portland Cement.

Ancient Egyptians described using block or mud brick to build many structures, such as scenes of block forming in the Rekhmire tomb at Sheikh abd el-Qurnaa area of Egypt. Other formulas for making structures or casting are detailed on the Famine Stele located on the island of Sehel, Egypt.

### BRIEF SUMMARY OF THE INVENTION

It is thus an object of the invention to provide a new type of inorganic cementitious material that will harden upon addition of water.

It is a further object of the invention to provide methods of using this new cementitious composition as a binder for aggregate, to make bricks, blocks, cast stonework, cultured stone, agglomerated stone, retaining walls, pipe, grout, mortar, gunnite, stucco and similar or other products.

These and other objects of the invention will be more fully understood in connection with the detailed description of the embodiments of the invention.

### BRIEF DESCRIPTIONS OF THE SEVERAL VIEWS OF THE DRAWING

Not Applicable

### DETAILED DESCRIPTIONS OF THE INVENTION

In this embodiment, a cementitious composition is created by a mixture of sodium carbonate (also known as soda ash, sodium carbonate decahydrate, sodium carbonate anhydrous, natron, trona, etc.) with one or more minerals from the calcium carbonate group (including aragonite, limestone, calcite, marble, dolomite, etc.). The amounts of components can vary between 10 and 90 wt % sodium carbonate to 90 and 10 wt % of one or more rocks and minerals from the group consisting of calcium carbonate as active ingredients.

The sodium carbonate can be in the form of sodium carbonate or as soda ash, sodium carbonate decahydrate, sodium carbonate anhydrous, natron, trona, etc.

As sources of one or more rocks and minerals from the calcium carbonate group include aragonite, limestone, calcite, marble, dolomite, etc.

One or more of the cementitious components may be in a wet state prior to mixing.

The fineness and grain size of the sodium carbonate and one or more rocks or minerals from the group consisting of calcium carbonate components not only affects the overall appearance of the final product, but also its strength.

The sodium carbonate and one or more rocks or minerals selected from the calcium carbonate source used in the invention can vary in particle size from that of powder, common sand, to dust, chips, clumps, or larger chunks of material. The particle size will normally be selected for the effect to be achieved in the finished product, and mixtures of particle sizes can be used in combination.

A colouring agent or dye may be included in the cementitious composition, thereby allowing the ability to individually tailor the final appearance of the cementitious composition.

As noted above, the resulting cementitious composition can be employed as a filler, grout, mortar, gunnite, masonry, bricks or blocks, decorative effect, architectural or cast stonework, ornamental or cultured stone or granite, retaining walls, wall claddings, panelling, counter panels, roof and floor tiles, pavers, precast stone, cobblestones, pipe, reinforced concrete, including prestressed, concrete mixtures and products, agglomerated stone products and mixtures, extruded and moulded products and composites. It can be used as insulated sheathing, thermal insulation, packing material and in housewares and appliances. It may be used as a component of boats, sailing crafts, temporary casts, table or countertops, bioabsorbable devices, electronic components, packaging, etc. alone or with other materials. It also finds utility as temporary fillings, temporary roads, temporary facilities, temporary shoring, temporary barriers, temporary support, temporary scaffolding, temporary walls, temporary docks, etc.

Aggregates which can be included within the cement include bedrock, traprock, quartz and quartzites, chryscolla, malachite, biotite and feldspar, etc.

It may be formed of a mixed homogeneous material or may take the form of a layered mix.

It is to be understood that variations and improvements may be made to the invention without departing from the spirit and scope of the appended claims.

1. A cementitious composition comprising:
a mixture of a source of 10% to 90% by weight sodium carbonate and 90% to 10% by weight and a source of calcium carbonate in uncalcined form, mixed with the presence or absence of aggregate;

2. A cementitious composition of claim 1, further including colouring agents or dyes.

3. A cementitious composition of claim 1, further including the presence or absence of a hardener.

4. A cementitious composition of claim 1, further including at least one synthetic or natural resin additive or a combination of synthetic or natural resin additives.

5. A cementitious composition of claim 1, further including at least one organic or inorganic additive or a combination of inorganic and organic additives.

6. A cementitious composition of claim 1, further including an air-entraining admixture.

7. A cementitious composition of claim 1, further including a waterproofing agent.

8. A cementitious composition of claim 1, wherein one or more of the cementitious components selected from the sodium carbonate group or the calcium carbonate group is in a wet state.

9. A cementitious composition of claim 1, wherein the calcium carbonate source is selected from the group consisting of limestone, dolomitic limestone, marble, calcite, dolomite, marble dust, aragonite and mixtures thereof.

10. A cememtitious composition of claim 1, wherein the sodium carbonate source is selected from the group consisting of trona, natron, soda ash, sodium carbonate decahydrate, sodium carbonate anhydrous and mixtures thereof.

11. A process for forming a cementitious composition comprising:
a mixture of a source of 10% to 90% by weight sodium carbonate and 90% to 10% by weight and a source of calcium carbonate in uncalcined form, mixed with the presence or absence of aggregate;

12. A process for forming a cementitious composition of claim 11, further including colouring agents or dyes.

13. A process for forming a cementitious composition of claim 11, further including the presence or absence of a hardener.

14. A process for forming a cementitious composition of claim 11, further including at least one synthetic or natural resin additive or a combination of synthetic or natural resin additives.

15. A process for forming a cementitious composition of claim 11, further including at least one organic or inorganic additive or a combination of inorganic and organic additives.

16. A process for forming a cementitious composition of claim 11, further including an air-entraining admixture.

17. A process for forming a cementitious composition of claim 11, further including a waterproofing agent.

18. A process for forming a cementitious composition of claim 11, wherein one or more of the cementitious components selected from the sodium carbonate source or calcium carbonate source is in a wet state.

19. A process for forming a cementitious composition of claim 11, wherein the calcium carbonate source is selected from the group consisting of limestone, dolomitic limestone, marble, calcite, dolomite, marble dust, aragonite and mixtures thereof.

20. A process for forming a cementitious composition of claim 11, wherein the sodium carbonate source is selected from the group consisting of trona, natron, soda ash, sodium carbonate decahydrate, sodium carbonate anhydrous and mixtures thereof.
